(19) United States
(12) Patent Application Publication
(10) Pub. No.: US 2023/0002984 A1
(43) Pub. Date: Jan. 5, 2023

(54) PEDESTRIAN FLOW CONTROL SYSTEM

(71) Applicant: EPS HOLDING GMBH, Krailing (DE)

(72) Inventor: Dirk BODA, Bergheim (DE)

(21) Appl. No.: 17/782,857

(22) PCT Filed: Dec. 4, 2020
(86) PCT No.: PCT/EP2020/084729

§ 371 Date: Jun. 6, 2022

(30) Foreign Application Priority Data
Dec. 5, 2019 (DE) 10 2019 133 253.2

(51) Int. Cl. E01F 13/02

(52) U.S. Cl. CPC E01F 13/022

(57) ABSTRACT

A pedestrian flow control system includes a first lateral boundary element and a second lateral boundary element, a passage for persons being formed between the lateral boundary elements; and a middle element arranged in the passage. The middle element is mounted at the bottom on a guide element oriented perpendicularly to the lateral boundary elements and can be moved along the guide element into at least a first position and a second position, is arranged between the lateral boundary elements and divides the passage into two aisles in the first position, openings the passage substantially over the whole width of the passage in the second position.

### BACKGROUND

Person-separating installations are used, for example, in the context of large events. The serve for separating groups of persons, for example in order to check them before admitting them to events. Such checks of people and baggage are carried out by security personnel in the person-separating installation or, in the direction of passage, behind it.

In a particularly simple embodiment, the venue is closed off by fences that have individual gates with a small width through which only a single person can pass at a time.

Also known are person-separating installation that have, in total, a width of several meters and have at least two, but usually a plurality of, parallel passages for people. Particularly in the case of stadiums, such person-separating installations are permanently installed. Prior to entering the stadium, the visitors line up with the various passages and pass them individually in order to be checked in or directly behind the passages by security personnel. Tickets are also often checked at this point.

Person-separating installations are often combined with entrance barriers, e.g. with turnstiles. In that case, the latter are most frequently located within the passages. They may either be manually opened in each case by on-site security personnel, or reading devices for tickets may be located in the entrance area, for example, via which the turnstiles are opened.

An essential property of person-separating installations is the fact that they have passage widths of only about 40-70 cm. The purpose of this small passage width is that people are able to pass through only individually, one after the other, and not two people next to each other. Now, the problem is that a separation of people is necessary only when they are admitted to the event, but not after the event when leaving the venue. In this case, the requirement actually is to guide the generally large number of people out of the venue as quickly and trouble-free as possible. In this case, the person-separating installations interfere to a considerable extent with the process. This drawback is even more serious in case of an emergency in which the venue has to be evacuated as quickly as possible. The applicable provisions require that there has to be a sufficient number of escape routes with passage widths of a corresponding size, with no obstacles being allowed in the escape route. Therefore, many venues have additional gates in the barriers or fences, which can be opened in case of an emergency. In this case, it is disadvantageous that they must first be unlocked and then manually opened, which often is not easy to do in case of a panic.

Also known are person-separating installations that have turnstiles that can be folded down. The goal of this is that the way back through the passages is clear, without obstacles. However, the width of the individual passage is not changed thereby, which is the reason why people have to run through the person-separating installation individually even when escaping.

### SUMMARY

The present disclosure provides a person-separating installation which, on the one hand, achieves a reliable separation of the persons for admission to a venue, and on the other hand is capable of providing an escape route with a sufficient width if necessary. It is essential that the person-separating installation fulfils the legal provisions with regard to the access of people to events but also with regard to the requirements for escape routes. Here, the person-separating installation is supposed to be capable of being as simple to operate as possible and with a low risk of error. At the same time, it is supposed to permanently function reliably and be resistant to dirt and moisture. The structure is supposed to be as simple as possible, and the service and maintenance requirements are supposed to be as small as possible.

According to the disclosure, the advantage is achieved by providing a person-separating installation having the features of claim 1. Other advantageous embodiments and details are described in the following description and in the dependent claims, which may be combined with each other in any manner that makes technical sense.

The person-separating installation according to the disclosure can be put into at least two states. On the one hand, it may be used for separating people, such as is necessary particularly in the case of an entrance situation for a venue. On the other hand, it can be put into a second state, in which it has a sufficient width of the passage for the exit situation, and particularly also for escape situations. In this case, it is essential that the person-separating installation has a robust and simple structure nevertheless, and that the transfer from the first position (entry situation) into the second position (exit situation) can be carried out in a quick, simple and reliable manner.

In the simplest basic version, a person-separating installation according to the disclosure has two lateral boundary members, between which a passage is located. In the first position, this passage is divided with a central member into two aisles that extend parallel. These aisles have a width of approximately 40-60 cm, so that persons are able to go through them only individually.

In the region of the floor, the central member is supported on a guide member orientated transversely to the lateral boundary members, or transversely to the direction of passage, and can be displaced along this guide member from the first position into the second position. Thus, the central member can be laterally moved out of the passage in the direction of one of the two lateral boundary members, so that then the entire passage is cleared. In both positions, the central member can be retained and/or locked in the respective position with suitable retaining members. In a particularly simple variant, the retaining members may be formed by a brake which acts on the central member and which can be released by a handle, for example. Alternatively, for example, a locking process with a bolt, which can be inserted into an opening in the guide member or an adjacent component, may be carried out. The central member is then unlocked only by pulling the bolt out of the opening, so that the central member can then be moved.

In a particularly advantageous embodiment, the guide member is located within or underneath a walk-on floor panel on which the persons pass through the person-separating installation. If the guide member is located underneath a walk-on floor panel, the central member extends with a vertical portion through a guide opening in the floor panel up to the guide member. The guide opening, which has an elongated configuration, is disposed above the guide member, so that the central member is displaceable.

It is a major advantage of the disclosure that the guide opening may be extremely narrow. This is important because the person-separating installation, or the floor panel, must not form any tripping hazards. In this regard, openings in the floor panel that are too large would be disadvantageous.

The vertical portion of the central member, e.g. a vertical post, may in this case be guided with its full diameter through the guide opening; in a particularly advantageous embodiment, however, it is also possible to reduce the diameter of the vertical post in the region of the guide opening in order to be able to make the guide opening even narrower. For example, a flat iron, which is guided through the guide opening and contacts the guide member or is supported thereon, may be connected to the vertical post on the floor side. Finally, it is possible to form the guide opening by an elongated slot whose width is only about 0.5 cm to 3 cm, preferably about 1 cm to 2 cm.

In a particularly advantageous embodiment, the guide opening is additionally protected from dirt by brush seals.

Both the lateral boundary members and the central member may preferably be configured as railings that each have two vertical posts and one horizontally extending handrail connecting the vertical posts. Accordingly, the central member is correspondingly guided on two guide members due to the two vertical posts. In particular, however, the two lateral boundary members may also be formed, instead of by railings, by vertically extending full-surface side walls, towards which the central member is moved in the second position, so that it is disposed directly adjacent to them. In this embodiment, a recess in the vertical wall is also conceivable, into which the central member is retractable into the second position, so that the entire passage between the two lateral boundary members is cleared also in that case.

In the event the lateral boundary members are configured as railings, the central member may also be moved laterally towards them, so that it clears the passage almost completely. In a particularly advantageous embodiment, however, the central member is configured to be shorter in the direction of passage, and also lower, than at least the lateral boundary by which it is located in the second position. Thus, in the second position the central member may be arranged underneath the lateral boundary or even outside the lateral boundary, with regard to the passage, so that the passage is cleared over its entire width.

The passage width between the two lateral boundary members corresponds to the requirements with regard to escape routes, so that additional exits for escape situations, e.g. in the form of gates that have to be opened, can be omitted.

According to the disclosure, the person-separating installation may also have a roof, which is advantageous particularly for personnel working in the area of the person-separating installation.

In a particularly advantageous embodiment, the central member may be moved from the first position into the second position and, optionally, back again by means of a drive unit. In this case, the drive unit may be configured as an electric drive unit, e.g. have a rack and a drive pinion. In a particularly advantageous embodiment, the drive unit is formed by a spring member, which is biased in the first position of the central member. A retaining member that can be triggered retains the central member in the first position. If the retaining member is triggered, the spring force of the spring member drives the central member such that it is moved from the first position into the second position. Thus, moving the central member without electrical power is possible, which is advantageous particularly in emergency situations and in the case of an electrical power failure.

For example, the retaining member may be formed by a simple hook that retains the central member in the first position against the spring force. For example, the hook can be triggered manually by moving the lever. In this case, the lever may contact the central member directly, or be configured as a unit with the retaining member; however, Bowden cables may also be provided in order to be able to position the lever at an easily accessible location.

Preferably, the drive member may also be formed by a gas pressure absorber or a gas pressure spring.

The retaining members or levers may also be configured so as to be operable via an electric actuator, with the electrical power preferably being provided by a battery. Thus, the person-separating installation are independent of the power grid and can be actuated reliably even in the case of a power failure. Operation may in this case preferably also be effected via a remote control on-site, or even centrally from a control room of the venue, so that several or even all person-separating installations can be transferred from the first into the second position with a single triggering command.

The guide member may be formed by any suitable guide member. A guide rail on which a carriage connected to the central member is movably supported has proved a particularly suitable embodiment. The carriage may be formed with or without rollers. In the case of a support on rollers, the rollers are preferably arranged within the carriage in order to be protected by the encapsulation from dirt and moisture.

For the basic function of the person-separating installation according to the disclosure, it is sufficient if the central member can be moved only in one direction, i.e. in the direction of one of the two boundary members. Accordingly, the guide members and the guide openings extend from approximately the center of the passage in the direction of and up to one of the two boundary members. Alternatively, it is also possible that the central member can be moved in both directions; accordingly, the guide members and the guide opening then extend over the entire passage width of the passage.

Preferably, the central member can be moved into a second position not only from a first position, but several intermediate positions can also be set. Thus, it is possible to change the width of the aisles formed thereby.

A table which can be folded down and/or up and which can be pivoted out in the direction of one of the two boundary members or even, optionally, in the direction of both boundary members, may be provided on the central member. Thus, the table can close off one of the two aisles formed by the central member. For this purpose, the boundary members have table retaining means that retain the table in the horizontal position. In a particularly simple embodiment, the table retaining members are formed by cross-beams on which the table rests.

Alternatively, it is possible to arrange the table on the lateral boundary members and let it rest on the central member.

According to the disclosure, several person-separating installations may be set-up side-by-side, combined into a person-separating system. It is thus possible to provide a relatively wide region with a plurality of passages. For this purpose, the lateral boundary members may preferably be formed by an intermediate member, which is approximately rectangular in a top view. For example, tables may be arranged within this rectangular intermediate member, which has a width of about 40 cm to 60 cm, for example. However, the free space may also be used for accommodating waste containers or as a space for security personnel.

In a particularly advantageous embodiment, the space within the intermediate members is used for arranging drive units for rotary barriers. The arms of the rotary barriers then extend into the aisles in the direction of the respective central members. In an emergency or in the exit situation, the arms are folded away in a downward direction, so that the passage is again cleared completely.

According to the disclosure, a table that can preferably be folded down may be connected to the intermediate members. In the direction of passage, the former may be arranged in front of or behind the passage. The width of the table is less than or, at most, equal to the width of the intermediate member, so that it does not protrude laterally into the passage.

In a particularly advantageous embodiment of an arrangement of several person-separating installations, their retaining members are connected to one another in such a way that several or all retaining members may be triggered by operating a single lever. This causes all central members to be simultaneously moved out of the passage and all escape routes to be cleared. The retaining members may in this case be mechanically connected via Bowden cables; however, a wireless connection via a data link is also conceivable.

### BRIEF DESCRIPTION OF THE DRAWINGS

The disclosure is explained further with reference to the following Figures. They are to be understood as mere examples and are not intended to limit the disclosure to the embodiments shown. In the Figures:

FIG. 1: shows three person-separating installations according to the disclosure as a person-separating system from the front, in an entrance situation,

FIG. 2: shows the person-separating system of FIG. 1 from above,

FIG. 3: shows the person-separating system of FIGS. 1 and 2 from the front, in an exit situation,

FIG. 4: shows the person-separating system of FIG. 3 from above, in an exit situation,

FIG. 5: shows the person-separating system of FIGS. 1 and 2 in a perspective view in an admission situation,

FIG. 6: shows the person-separating system of FIGS. 3 and 4 in a perspective view in an exit situation,

FIG. 7: shows a second embodiment of a person-separating system from above in the admission situation, and

FIG. 8: shows the person-separating system of FIG. 7 from above, in an exit situation.

### DETAILED DESCRIPTION OF THE DRAWINGS

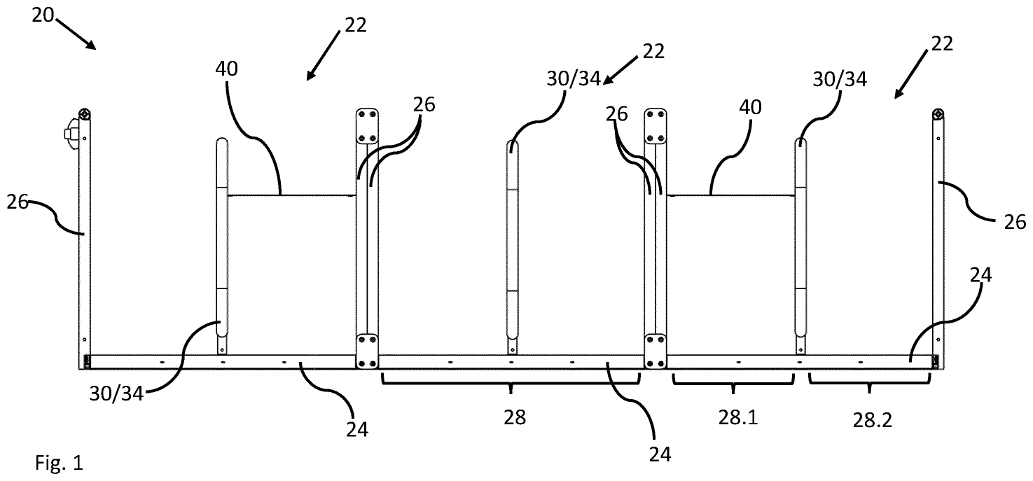

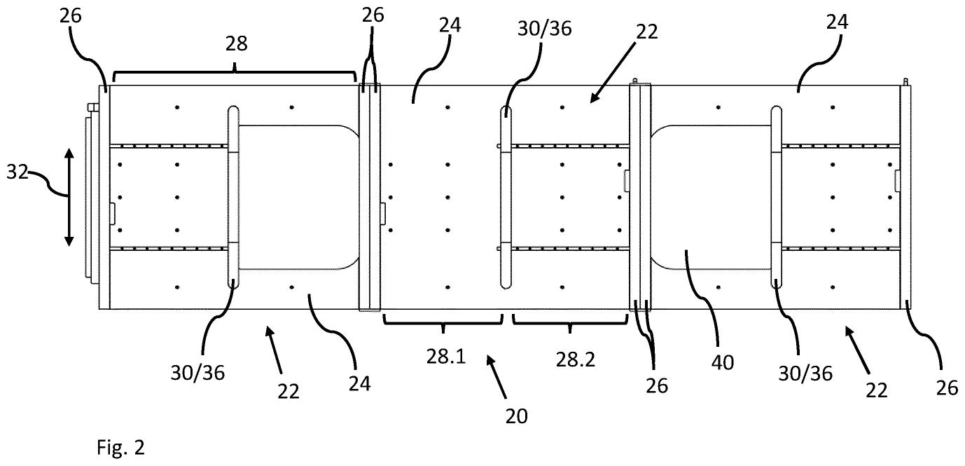

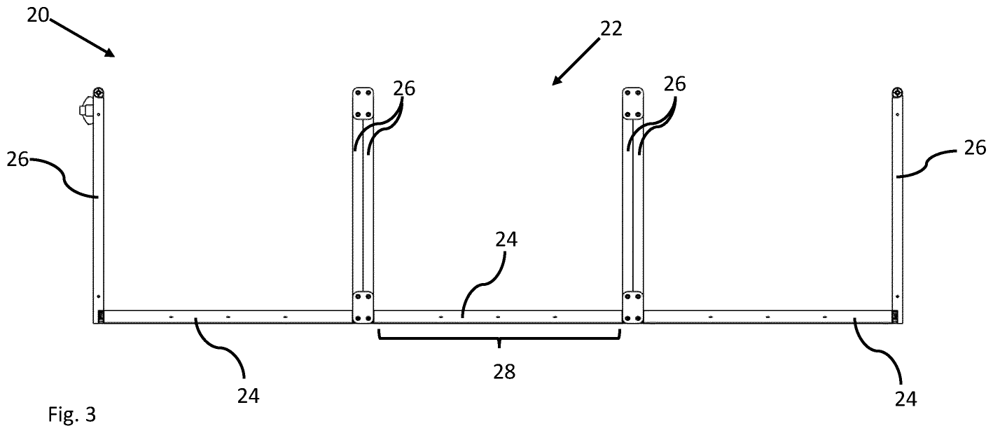

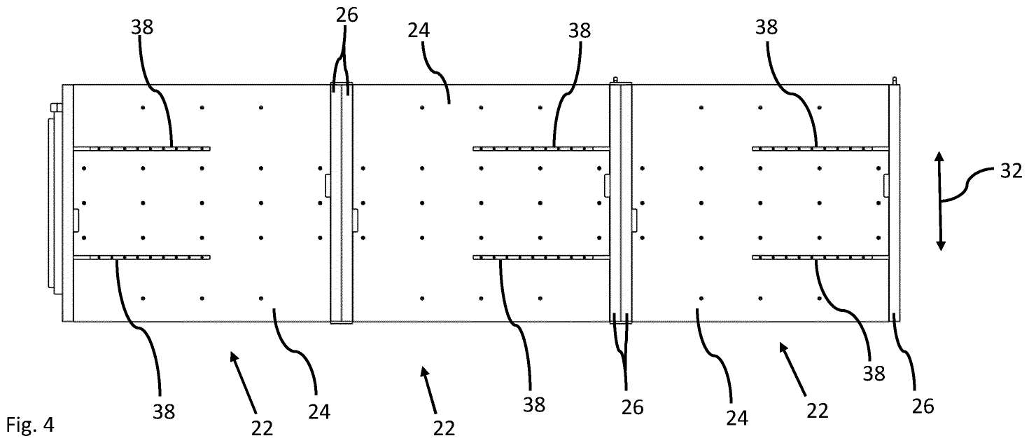

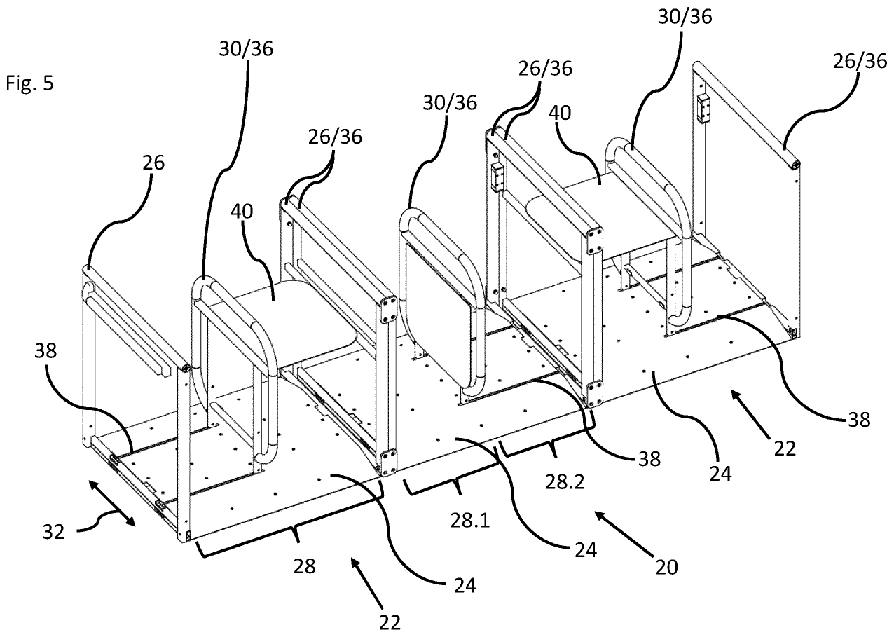

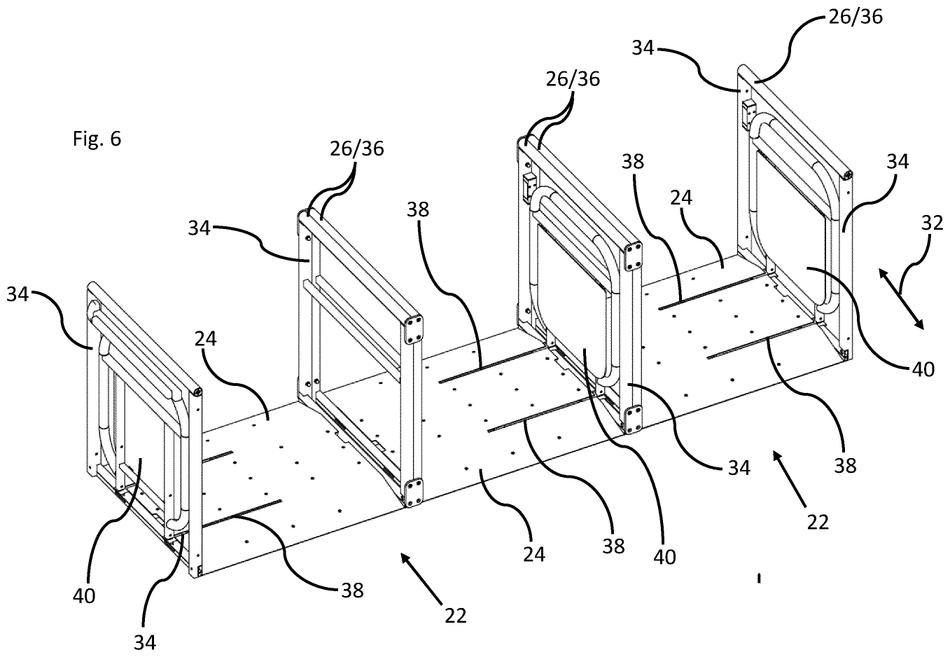

FIGS. 1-7 depict a person-separating system 20 respectively formed from three person-separating installations 22 arranged side-by-side. FIGS. 1, 2, 5 and 7 shows the person-separating installations 22 in the admission situation, FIGS. 3, 4, 6 and 8 in the exit situation.

The person-separating installations 22 each have a walk-on floor panel 24. Moreover, two lateral boundary members 26 are visible in each case, which are respectively attached to the floor panel 24 and protrude vertically upwards. In the depicted embodiments, the inner boundary members 26 of the person-separating system 20 are connected to one another.

A passage 28 is formed between the lateral boundary members 26.

On the floor panel 24, one central member 30 is in each case disposed between the two lateral boundary members 26, which also extends vertically upwards starting from the floor panel 24.

From a first position, in which it is located approximately in the center between the two lateral boundary members 26 in the depicted exemplary embodiments, the central member 30 can be moved into a second position. In the second position, the central member 30 is located outside the passage 28 in the depicted exemplary embodiments.

In the first position of the central member 30, it divides the passage 28 into two aisles 28.1, 28.2. In contrast, the passage 28 is clear over its entire width in the second position.

In the depicted exemplary embodiment, the clear width of the passage 28 is about 100 cm to 150 cm, preferably 120 cm. Accordingly, the clear width of the two aisles 28.1, 28.2 is in each case about 50 cm to 60 cm. The height of the lateral boundary members 26 is about 80 cm to 130 cm. In contrast, the central member 30 has a height of only 60 cm to 100 cm. The depth of a person-separating installation 22 in the direction 32 of passage, illustrated by a double-headed arrow, is about 80 cm to 120 cm, preferably 100 cm.

In the depicted exemplary embodiment, the lateral boundary members 26 and also the central member 30 have a U-shaped configuration; they each have two vertical posts 34 that are connected to each other by a horizontally orientated handrail 36. In this case, the depth or length of the handrails 36 of the two lateral boundary members 26 in the depicted exemplary embodiment approximately corresponds to the depth of the floor panel 24. In contrast, the length or depth of the handrail 36 of the central member 30 is shorter, so that a central member 30 can be positioned in the second position between the vertical posts 34 and underneath the handrail 36 of the corresponding lateral boundary member 26. The corresponding lateral boundary member 26 then surrounds the central member 30, so to speak, so that the latter no longer reduces the clear passage 28.

A guide member, which is not shown and on which the central member 30 is displaceably supported, is arranged in or underneath the floor panel 24. In the depicted exemplary embodiment, one central member 30 is respectively displaceably supported on, in each case, two guide members via its two vertical posts 34. The guide members extend transversely to the direction 28 of passage across one of the two aisles 28.1, 28.2. If the guide members are arranged underneath the floor panel 24, the floor panel 24 correspondingly has slot-like, elongated guide openings 38, which extend parallel to the guide members and through which the vertical posts 34 extend. The guide openings 38 are preferably sealed against soiling by bristle seals disposed therein.

A person-separating installation 22 according to the disclosure or a person-separating system 20 according to the disclosure may be provided in different embodiments. In FIGS. 1-6, an embodiment is shown in which tables 40 are respectively arranged on the central members 30. The tables 40 are pivotably mounted and, in the first position, rest on one of the lateral boundary members 26 or a transverse post arranged therein. As required, the tables 40 may be respectively arranged in the left aisle 28.1 or in the right aisle 28.2; however, they may also remain folded down, so that both aisles 28.1 and 28.2 stay clear.

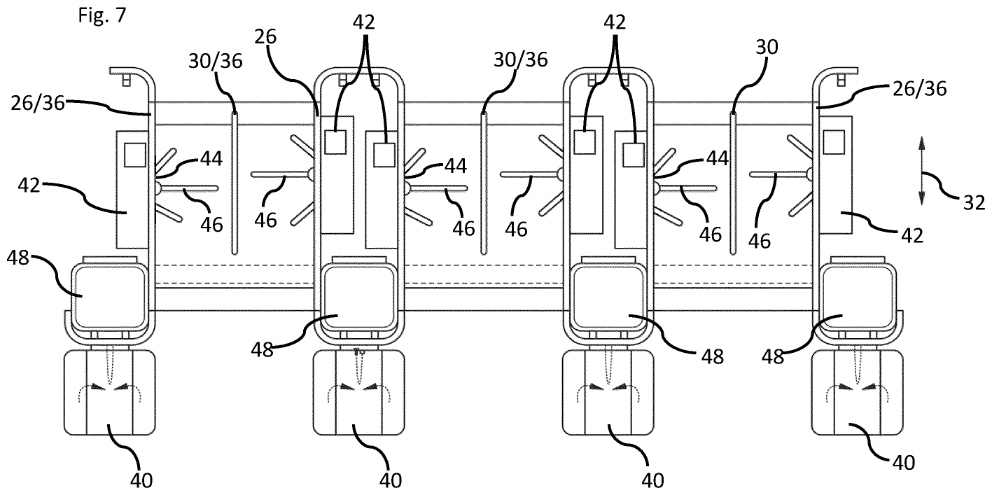

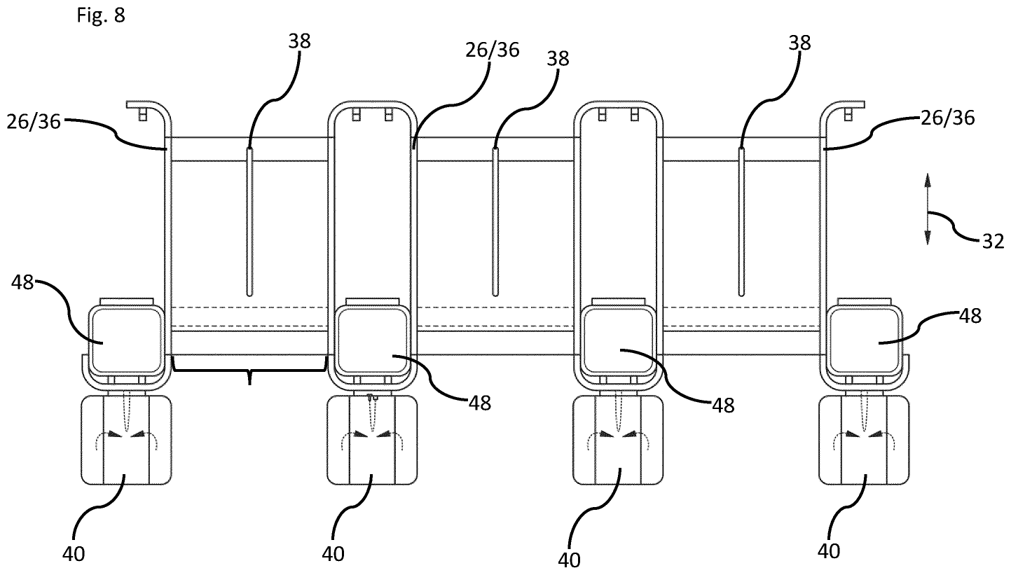

In the embodiment according to FIGS. 7 and 8, the lateral boundary members 26 of the person-separating installations 22 have approximately rectangular, peripherally extending handrails 36. Thus, a free space is formed within the handrails 36, which can be used in different manners. In the depicted exemplary embodiment, drive units 42 for turnstiles 44, whose arms 46 reach into the aisles 28.1 and 28.2, are arranged there. Thus, the aisles 28.1, 28.2 can be blocked by the turnstiles 44 or their arms 46.

Moreover, waste containers 48 are arranged within the boundary members 26. At the ends, the boundary members 26 have foldable tables 40 that are no wider than the boundary members 26 and thus do not protrude into the passages 28.

FIG. 8 illustrates that the arms 46 of the turnstiles 44 are configured to be foldable, so that in the second position of the central member 30, they do not protrude into the passage 28 and clear the escape route. In this case, the turnstiles 44 and the arms 46 have dimensions that do not impede a displacement of the central member 30 into the second position.

The Figures also show a lever 50 via which the retaining members, which are not shown, can be triggered, which retain the central members 30 in the first position against a spring force of the spring members. If the lever 50 is operated, the retaining members release the central members 30, so that the latter automatically move into the second position.

The disclosure is not limited to the exemplary embodiments shown, but also includes other variants of the disclosure. In particular, further elements may be arranged on the lateral boundary members 26. For example, devices for automatically checking access authorizations are conceivable.

1. A person-separating installation, comprising:
a first lateral boundary member and a second lateral boundary member, wherein a passage for persons is formed between the first and second lateral boundary members,
a central member, which is disposed in the passage, and which
is supported on the floor side on a guide member orientated transversely to the lateral boundary members and is displaceable along the guide member into at least one first position and one second position,
in the at least one first position, is arranged between the lateral boundary members and divides the passage into two aisles,
in the at least one second position, clears the passage substantially over its entire width.

2. The person-separating installation according to claim 1, wherein the guide member is disposed underneath a walk-on floor panel, which has a guide opening, which extends above the guide member and along the guide member, and through which extends a vertical post of the central member that is guided through the guide member.

3. The person-separating installation according to claim 1, wherein the guide member extends approximately from the center of the passage to one of the two lateral boundary members.

4. The person-separating installation according to claim 1, wherein the central member is configured as a u-shaped railing with two vertical posts and a handrail horizontally connecting the two vertical posts.

5. The person-separating installation according to claim 1, wherein the lateral boundary members are configured as u-shaped railings with in each case two vertical posts and a handrail horizontally connecting the vertical posts.

6. The person-separating installation according to claim 1, wherein in the second position, the central member is located completely outside the passage.

7. The person-separating installation according to claim 1, wherein the central member has a lower height than at least one of the lateral boundary members and, in the direction of passage, a smaller length than at least one of the lateral boundary members, and the central member, in the second position, is located between the vertical posts and underneath the handrail of the corresponding lateral boundary member.

8. The person-separating installation according to claim 1, wherein the central member is configured to be moved up to one of the boundary members and is disposed directly adjacent to this boundary member in the second position.

9. The person-separating installation according to claim 1, wherein the central member is configured to be moved from the first position into the second position by a drive unit.

10. The person-separating installation according to claim 1, wherein the drive unit is formed by a spring member, which is biased in the first position of the central member and held by a retaining member configured to be triggered, wherein a triggering of the retaining member causes a movement from the first position into the second position due to the spring force.

11. The person-separating installation according to claim 10, wherein the retaining member is connected via a Bowden cable to a lever, via which the retaining member is configured to be triggered.

12. The person-separating installation according to claim 10, wherein the retaining member is configured to be triggered via an electric actuator, wherein the electric member is provided with electrical power via a battery.

13. The person-separating installation according to claim 12, wherein the electric actuator is configured to be remotely controlled by a remote control.

14. A person-separating system formed from at least two person-separating installations according to claim 1.

15. The person-separating system according to claim 14, wherein the retaining members of the central members are connected to each other such that the retaining members are configured to be triggered together.
